(19) United States
(12) Patent Application Publication
(10) Pub. No.: US 2013/0319700 A1
(43) Pub. Date: Dec. 5, 2013

(54) SEED DRILL WITH MULTI-ROW SOWING ELEMENTS

(71) Applicant: Egidio Maschio, Campodarsego (PD) (IT)

(72) Inventor: Egidio Maschio, Campodarsego (PD) (IT)

(73) Assignee: MASCHIO GASPARDO S.P.A, Campodarsego (PD) (IT)

(21) Appl. No.: 14/000,218

(22) PCT Filed: Feb. 20, 2012
(86) PCT No.: PCT/IB2012/050758

§ 371 Date: Aug. 18, 2013

(30) Foreign Application Priority Data
Feb. 18, 2011 (IT) PD2011A000048

(51) Int. Cl. A01C 5/06

(52) U.S. Cl. CPC A01C 5/064; A01C 5/068
USPC 172/166

(57) ABSTRACT

A seed drill with multi-row sowing elements including at least two rows (3, 4) of sowing elements (5), each connected to a respective element carrying bar (9, 10), the bars (9, 10) being parallel and spaced apart, and maintained thus by respective bar supports with respect to which the bars (9, 10) are rotatably supported about their own axis; the bars (9, 10) are connected to each other in rotation in such a way that the rotation of one with respect to the supporting structure is transmitted in an identical manner to the other bar.

The invention relates to a seed drill with multi-row sowing elements. Seed drills of the type indicated are known for example from EP1964459.

Such seed drills have in common the fact that the sowing elements are mounted on a bar which is itself rotatably supported on the frame of the machine. The sowing elements are articulated on support arms fixed to the bar and such that, by rotating the bar, the sowing depth of all the sowing elements is varied at the same time. This capability permits very rapid adjustment of the sowing parameters which is particularly valued by users.

However, when the sowing elements are close together, for example when a relatively narrow spacing between sowing lines is required, it is necessary to arrange the elements in multiple rows (typically two) staggered in such a way that the sowing elements of the first row are further forward than the sowing elements of the second row. Otherwise, adjacent elements would interfere with one another or could give rise to clogging phenomena.

A known technical solution for staggering the rows of sowing elements involves the use of support arms of different lengths fixed to the bar. In particular, the arms which carry the second row of sowing elements must be longer than the arms which carry the first row.

This solution, however, has the drawback that, by reason of the different lengths of the support arms, the effect produced on the sowing elements of the two (or more) rows is necessarily different, and this alters in a different way the adjustment for example of the pressure and consequently of the sowing depth of the two rows of elements.

Another solution, described in utility model DE 10 2010 002200, provides for the use of two separate bars for supporting the sowing elements, and the connection of the two bars by means of a parallelogram system, in such a way that the rotation of one bar is transferred to the other. However, in this case also, the two bars act differently on the elements of each row, and not even this solution makes it possible to maintain an equal pressure produced by the sowing elements of the two rows except for very limited variations of the sowing depth.

The problem underlying the present invention is that of providing a seed drill with multi-row sowing elements structurally and functionally designed to remedy all the drawbacks mentioned with reference to the prior art cited.

This problem is solved by the invention by means of a seed drill produced in accordance with the following claims.

Within the field of this problem, the invention offers the possibility of ensuring a constant pressure on the sowing elements of the different rows within a wide range of variation of the sowing depth.

The features and advantages of the invention will become clear from the detailed description of a preferred, but not exclusive, exemplary embodiment thereof, illustrated by way of non-limiting example with reference to the appended drawings, in which:

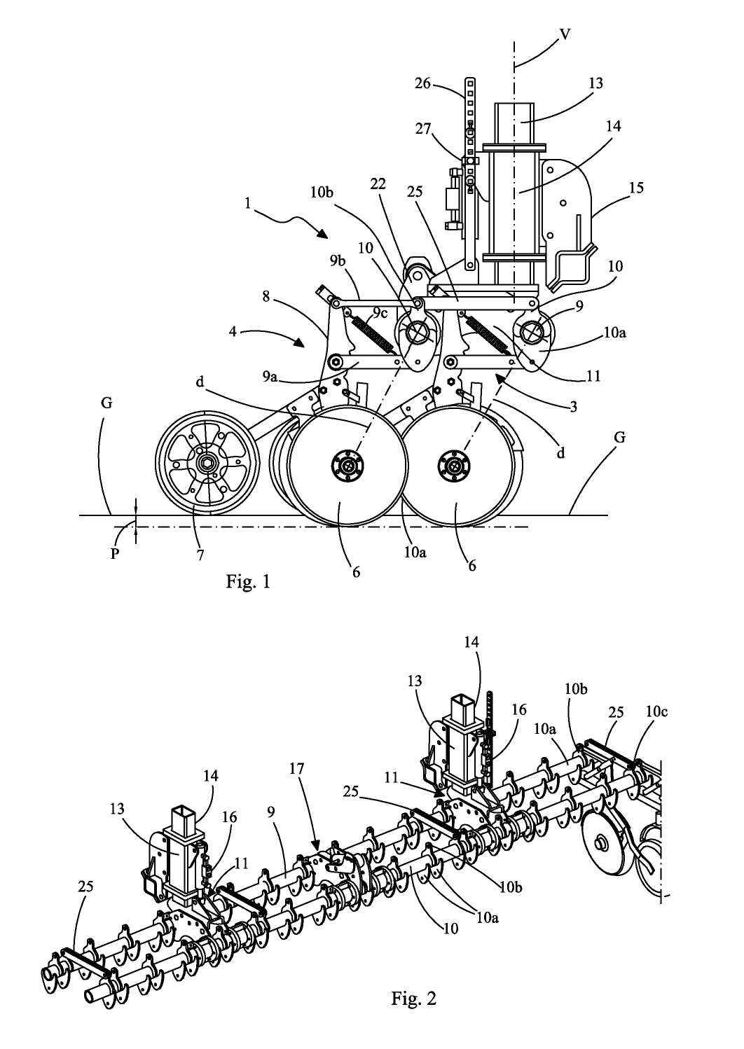

FIG. 1 is a view in side elevation of a seed drill according to the present invention;

FIGS. 2 to 7 are partial perspective views of details of the seed drill of FIG. 1;

FIG. 8 is a view in side elevation of a second form of embodiment of the seed drill according to the present invention; and

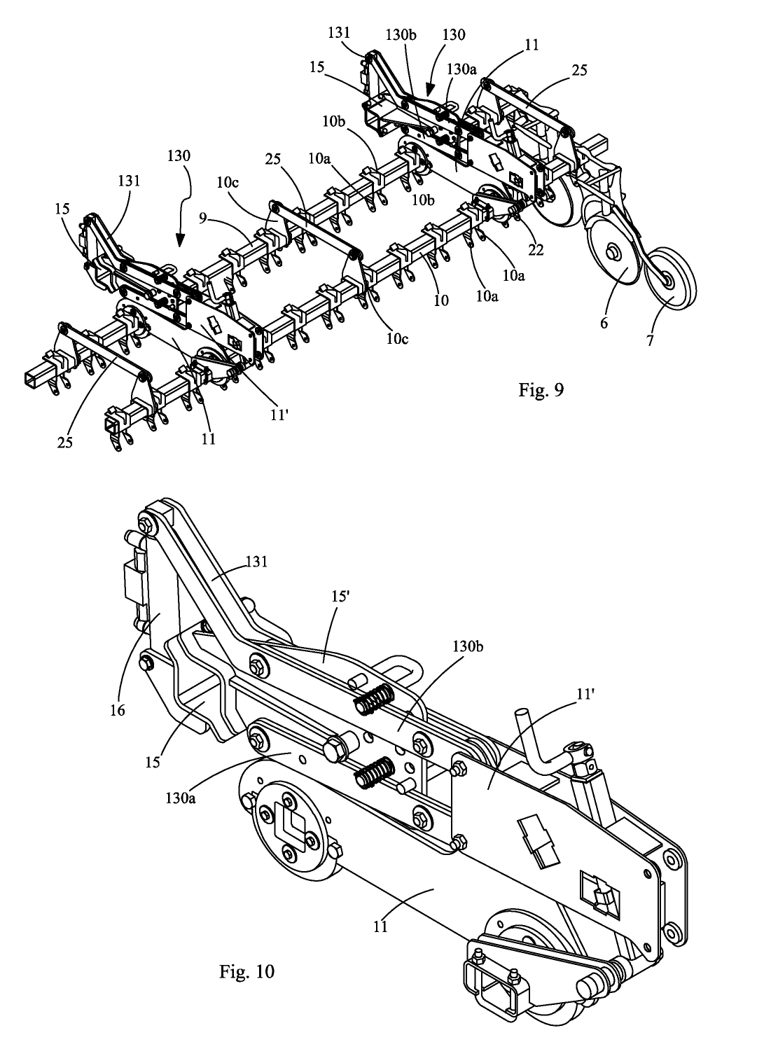

FIGS. 9 and 10 are partial perspective views of details of the seed drill of FIG. 8.

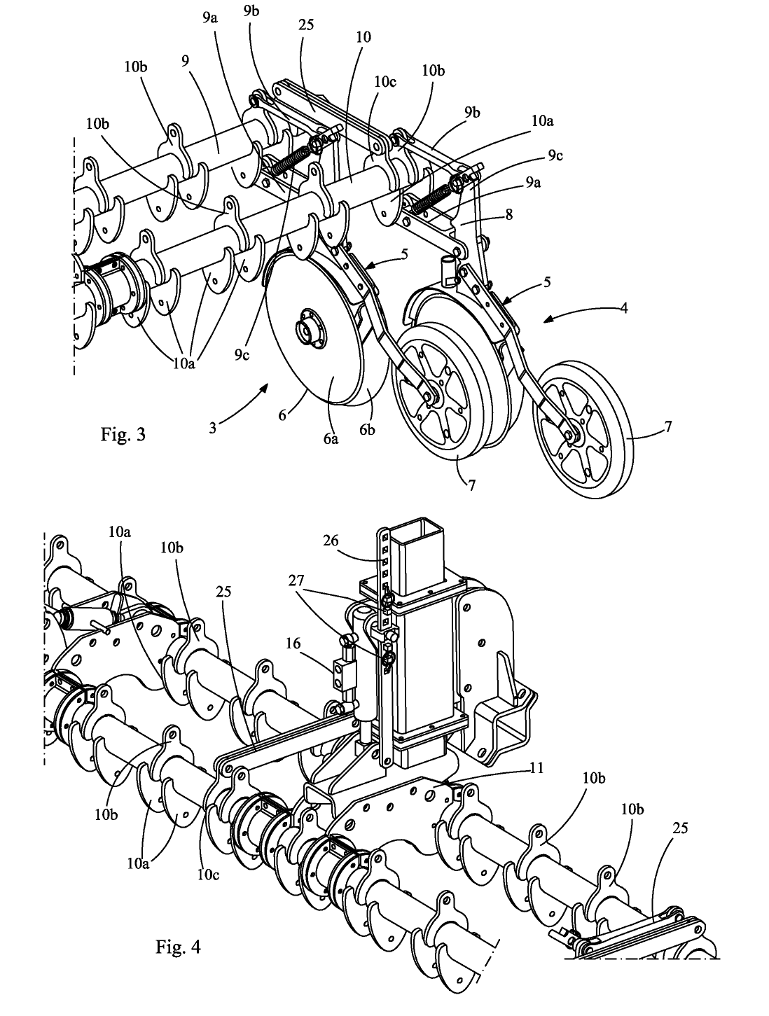

With initial reference to FIG. 1, a seed drill according to the present invention is indicated as a whole by the reference number 1 and comprises at least two rows 3, 4 of sowing elements 5, illustrated in more detail in FIG. 3. Each sowing element 5 includes a respective sowing coulter 6 with double disc 6a, 6b and a depth adjusting wheel. The sowing coulter and the wheel 7 are connected to a respective support 8 (which supports are very similar, but not identical, inasmuch as the staggering of the discs of the coulter of the two rows is opposed) also constituting one of the sides of an articulated parallelogram by means of which the sowing element is connected to a respective bar 9, 10 which carries elements 5 of circular or square cross-section, as in the exemplary embodiments of FIGS. 8 to 10. In more detail, the articulated parallelogram is formed by two arms 9a, 9b and a further side formed by appendages 10a, 10b fixed to the corresponding bar in such a way as to be solidly fixed in rotation therewith, as will be described in more detail hereinafter. A spring 9c interconnects the articulation of the upper arm 9b of the parallelogram to a point of the lower arm in order to impart a suitable resilient load to the sowing element 5. As an alternative to the spring 9c, other equivalent resilient elements may also be provided which maintain the parallelogram, or more generally the support 8, in a balanced position. This position defines the sowing depth “p” of the sowing elements 5, this being dependent on the distance in a vertical direction between the bearing point at a working surface, defined by the ground G, of the wheel 7, and the point of maximum penetration into the ground G of the discs of 6a, 6b. It should be noted that, in the context of the present invention, the vertical direction is identified by the direction perpendicular to the plane defined by the ground on which the coulter acts.

Moreover, it is clear that, as the configuration of the parallelogram is varied, the distance “p” is varied, therefore obtaining a different sowing depth. As emphasized previously, with each of the aforesaid bars 9, 10 there is associated a respective row of elements 5, the bars being parallel and spaced apart and maintained thus by bar supports 11, illustrated more clearly in FIGS. 2 and 6, and with respect to which the bars are rotatably supported about their own axis. To this end, as illustrated in FIG. 6, the bar supports 11 have support bearings 12 for the bars, such as bushes made of material with a low coefficient of friction, which surround each bar rotatably while maintaining them at a predetermined distance between centres. The bushes of one bar are fixed to those of the adjacent bar by means of flanges 20 thus, as a whole, defining the support.

The bar supports 11 are themselves fixed to the end of a respective slide 13 which can slide vertically in a corresponding guide 14 carried by a supporting structure 15 or framework of the seed drill. The bars can thus be positioned adjustably with respect to the supporting structure of the seed drill by means of a jack 16 or some other spacing device with variable length which is interposed between the bar support 11 and the guide 14 of the corresponding slide.

This adjustment makes it possible to vary the sowing pressure in an identical manner for both the rows of sowing elements, permitting uniform sowing. The movement of the slide 13 permits an identical action of moving closer to or further away from the ground for both of the bars 9, 10, and the sowing pressure is consequently varied in a similar manner for all the sowing elements 5.

Finally, a rod 26 is provided, equipped with adjustable end-of-travel devices 27 for limiting the vertical displacement of the two bars and corresponding sowing elements with respect to the supporting structure.

As an alternative to the system formed by the slide 13 and guide 14, a parallelogram type system or other equivalent movement devices may also be provided which, similarly to the embodiment solution just described, make it possible to vary the vertical position of the bar supports 11.

An alternative embodiment solution is described in FIGS. 8 to 10, in which the movement device is formed by means of a parallelogram, identified as a whole by the reference number 130.

In that form of embodiment, the supports 11 comprise a transverse extension 11′ which defines an arm of the parallelogram, to which are rotatably connected lower and upper arms 130a, 130b. The arms are themselves rotatably connected to the supporting structure 15, in the region of a corresponding plate 15′, defining the arm parallel to the arm 11′ and the parallelogram 130 as a whole. The movement of the parallelogram is obtained by means of the jack 16 connected to the structure 15 and to an appendage 131 of the upper arm 130b, which is caused to rotate by means of the linear variation of the jack 16.

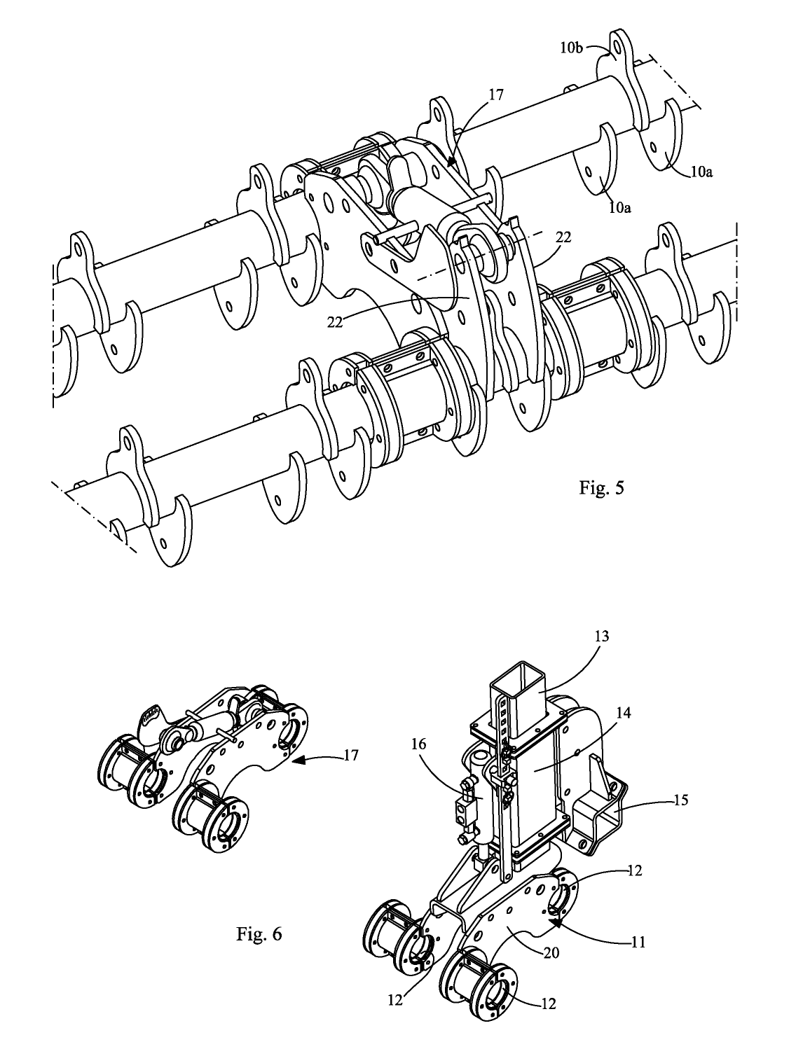

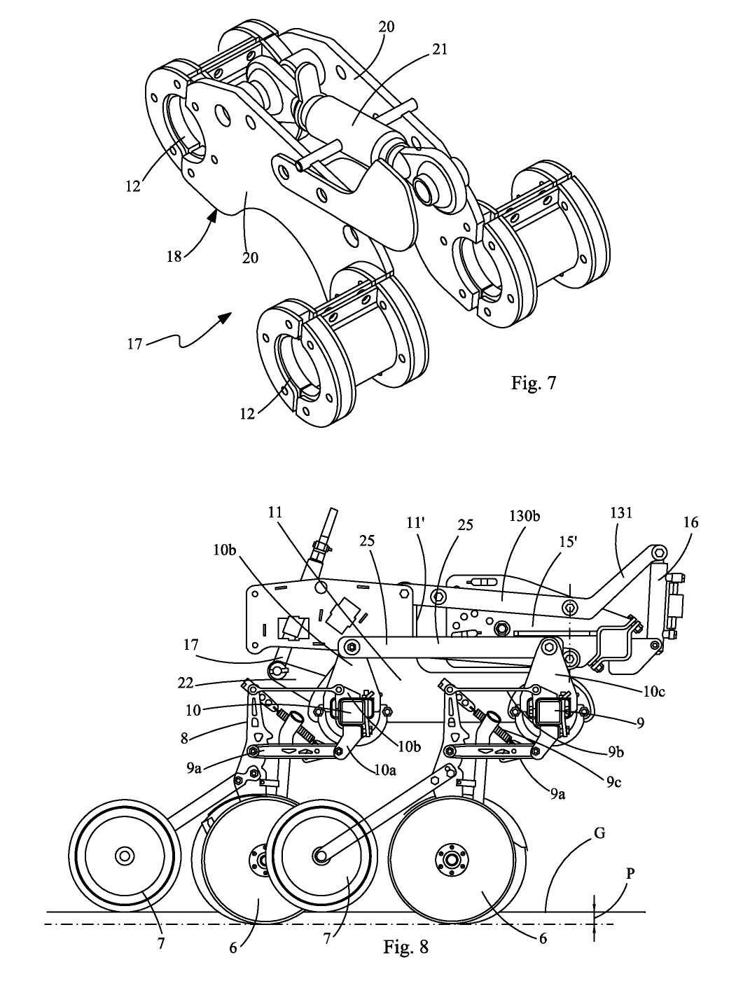

With reference again to FIG. 2, between the two or more bars an orienting device 17 is interposed which allows the two bars 9, 10 to be rotated with respect to the supporting structure of the seed drill. The orienting device 17, illustrated in more detail in FIGS. 5 and 7, comprises a bar support 18, substantially identical to the flanges of the supports 11, rotatably mounted on the two bars 9, 10 by means of bearings 12 and secured to one of the two bars, in particular the bar 10, by means of a jack 21 or other equivalent actuating means, such as, for example, a screw coupling extending between the supports 18, on the one hand, and a pair of arms 22 which extend radially from the bar 10 and are rigidly fixed thereto. In this way, by varying the extension of the jack 21 the rotation of a bar with respect to the supporting structure is obtained. The two bars 9, 10 are themselves connected to each other in rotation by means of pairs of connecting rods 25 which connect respective appendages 10c of adjacent bars to each other in such a way that the rotation of one with respect to the supporting structure is transmitted identically to the other bar.

As emphasized previously, the bars 9, 10 are provided with the appendages 10a, 10b extending from opposite sides with respect to the axis of the corresponding bar and constituting the points of attachment of the bars 9, 10 of the articulated parallelogram. In other words, the rotation of the bar produces a corresponding rotation on the arm of the parallelogram defined by the two appendages 10a, 10b, with a consequent movement of the other arms 9, 10 and of the support 8. In particular, as a result of the rotation of the bars 9, 10, the configuration of the parallelogram and the inclination of the support 8 will therefore be varied, thus modifying the sowing depth “p”.

However, since the parallelograms connected to each bar have the same characteristics, the rotation of the bars produces the same variation in the configuration of the two parallelograms, making it possible to maintain the same sowing characteristics, in terms of pressure and depth, for the two rows.

More generally, it should be noted that this feature may be produced also by different constructional solutions, in which provision is made for the rotation of the bars to act in the same manner on the resilient elements and produce an identical variation of the sowing depth of the elements of each row.

In particular, as illustrated in FIG. 1, this solution is in general produced by providing for the distance “d” between the sowing elements 5 connected to one bar and the centre of rotation of that bar, to be equal to that of the sowing elements 5 connected to the other bar.

Owing to this feature and, specifically, to the fact that use is made of appendages and arms of the parallelogram on the bars of equal dimensions, by rotating the bars with respect to each other the same relative positioning of the coulters and of the wheels 7 is obtained, maximising the homogeneity of adjustment of the sowing depth and of the pressure exerted by the wheels 7 between the two rows of elements 5.

It should furthermore be noted that such adjustment is completely independent of that effected by means of the movement device 13 and it is consequently possible to adjust sowing depth and pressure independently of each other, while maintaining complete homogeneity between the sowing elements of each row. The invention thus solves the problem posed, providing numerous advantages including that of permitting easy variation of the sowing characteristics, while maintaining perfect homogeneity between the two rows in terms of pressure and depth, owing to the independent action on the one hand of the device for vertical movement of the bar support and on the other of the simultaneous and identical rotation of the bars 9, 10.

This feature makes it possible to adjust the sowing conditions in a rapid and simple manner without having recourse to repeated tests and successive adjustments.

The vertical movement of the bars in fact produces a modification in the configuration of the parallelograms, with a consequent modification of the extension of the resilient element 9c and of the corresponding sowing pressure, without however altering the sowing depth, inasmuch as the relative distance between the wheel 7 and discs 6 is not varied. In this way, the operations of adjustment of the pressure and of the depth can be carried out independently. Moreover, the use of parallelograms in which one of the arms is fixed to a respective bar and set in rotation therewith makes it possible to ensure at the same time an identical variation of the sowing depth and of the response of the resilient element used.

In addition, the coulters and the disc respond in the same manner to any variations in the terrain, being subject to the same movement in a vertical direction.

1. A seed drill with multi-row sowing elements including at least two rows of sowing elements, each element including a respective sowing coulter and a wheel for adjusting the sowing depth, the sowing coulter and the corresponding wheel being connected to a support by means of which the sowing element is connected to a respective element carrying bar, in such a way that the rotation of the bars determines a different sowing depth (p) in the sowing elements, the bars being connected to each other in rotation so that the rotation of one with respect to the supporting structure is transmitted identically to the other bar, further comprising a movement device capable of varying the position of the bars in an identical manner in a vertical direction (v) and in that the rotation of the bars about their axis produces the same variation of the sowing depth (p) on the sowing elements of each row.

2. The seed drill according to claim 1, wherein the sowing depth (p) depends on the distance in a vertical direction between a bearing point at a working surface (G) of the wheel and a point of maximum penetration in the surface (G) of the discs.

3. The seed drill according to claim 1, wherein the distance (d) between the sowing elements connected to a first bar and the centre of rotation of the first bar, is equal to the distance (d) between the sowing elements connected to a second bar and the centre of rotation of the second bar.

4. The seed drill according to claim 1, wherein the sowing elements are connected to the respective bar by means of a resilient element, the rotation of the bars acting in an identical manner on the respective resilient element associated with each bar.

5. The seed drill according to claim 1, wherein the support constitutes one of the sides of an articulated parallelogram by means of which the sowing element is connected to the corresponding bar, the parallelogram including two arms and a further side formed by appendages fixed to the bar.

6. The seed drill according to claim 4, wherein the resilient elements include a spring which interconnects the articulation of an upper arm of the parallelogram with a point of a lower arm in order to impart a suitable resilient load to the sowing element.

7. The seed drill according to claim 1, wherein the bar supports have support bearings for the bars which surround each bar rotatably while maintaining them at a predetermined distance between centres.

8. The seed drill according to claim 7, wherein the bearings of one bar are fixed to those of the adjacent bar by flanges.

9. The seed drill according to claim 1, wherein the bars are parallel to and spaced from each other, and maintained thus by bar support elements with respect to which the bars are rotatably supported about their own axis.

10. The seed drill according to claim 9, wherein the movement device is connected to at least one of the bar supports, in such a way as to vary the position thereof in said vertical direction.

11. The seed drill according to claim 10, wherein the movement device comprises a respective slide for connection to the bar supports and able to slide in a corresponding guide carried by a supporting structure of the seed drill.

12. The seed drill according to claim 10, wherein the movement device comprises a parallelogram mechanism in which one arm is connected to the bar supports and the corresponding parallel side is carried by a supporting structure of the seed drill.

13. The seed drill according to claim 1, in which between the bars an orienting device is interposed which makes it possible to rotate the two bars with respect to the supporting structure of the seed drill.

14. The seed drill according to claim 13, wherein the orienting device comprises a bar support rotatably mounted on the bars and secured to one of the bars by an adjustable actuating means.

15. The seed drill according to claim 14, wherein the actuating means is of linear type, and is connected at one of its ends to flanges of the orienting device by which the bearings of one bar are fixed to those of the adjacent bar, and, at its opposite end, to a pair of arms rigidly fixed onto one of the bars so that by varying the extension of the actuating means the rotation of both the bars is obtained.
